(19) United States
(12) Patent Application Publication
(10) Pub. No.: US 2016/0213036 A1
(43) Pub. Date: Jul. 28, 2016

(54) Method of Preparing Edible Composition

(71) Applicant: TATE & LYLE INGREDIENTS AMERICAS LLC, Hoffman Estates, IL (US)

(72) Inventors: Shiji Shen, Algonquin, IL (US); Andrew J. Hoffman, West Point, IN (US); Susan E. Butler, Decatur, IL (US)

(21) Appl. No.: 14/913,321

(22) PCT Filed: Aug. 22, 2014
(86) PCT No.: PCT/GB2014/052576

§ 371 Date: Feb. 19, 2016

Related U.S. Application Data
(60) Provisional application No. 61/869,845, filed on Aug. 26, 2013.

(51) Int. Cl. A23L 1/01; A23L 3/34; A23L 1/22

(52) U.S. Cl. CPC A23L 1/22008; A23L 1/0035; A23L 1/005; A23L 1/237; A23L 3/34; A23V 2002/00

(57) ABSTRACT

A method of preparing a free-flowing, edible composition, comprising first and second edible materials, having first and second function-release profiles respectively, comprising: combining the first and second edible materials in dry particulate form; and heating said combination to a forming temperature, which is at least equal to the glass transition temperature of the first edible material, with concurrent mixing, so as to coat particles of the first edible material with a plurality of particles of the second edible material, thereby forming composite particles of said composition. Each of the first and second edible materials may be mixed with other edible materials prior to their combination. Also a free-flowing edible composition comprising a plurality of composite particles, each composite particle comprising a core of the first edible material provided with a discontinuous surface coating formed from a plurality of particles of the second edible material.

The present invention relates to a method of preparing a free-flowing edible composition comprising a first edible material, having a first function-release profile, and a second edible material, having a second function-release profile and to a free-flowing edible composition comprising a first edible material, having a first function-release profile, and a second edible material, having a second function-release profile that may be produced by said method.

Reduction in the amounts of certain food ingredients in our diets has been of increasing concern and importance over the last few decades, particularly in the amounts of flavourings such as salt (i.e. sodium chloride) and refined sugar (i.e. sucrose), for both health-related and cost reasons. Various methods have been proposed to effect such reductions, e.g. ingredient replacement, use of enhancing co-ingredients, use of sensory enhancers, with a view to at least maintaining the desired effect of the ingredient, e.g. taste improvement or enhancement.

Despite often positive benefits, unfortunately, however, the proposed methods and their products have also presented further problems to a greater or lesser extent, including the consumer experiencing an “off-taste” and/or an unpleasant or disagreeable “after-taste” from the product, increased cost due to the use of additional ingredients and/or processing steps, and difficulty in storing and handling the product.

Taking salt, being a ubiquitous food and beverage ingredient, as a particular example, it had been proposed to effect salt reduction by reducing the average particle size of the sodium chloride crystals. Ordinary table salt particles are typically in the range of from 1000 μm to 5000 μm. Reducing the particle size to below 100 μm, for example, has been found to provide an intense salt taste, thought to be due to more rapid and complete solubilisation in a consumer's mouth of the reduced size particles as compared to the larger particles. However, the smaller salt particles are difficult to manufacture and stabilize, as they very rapidly agglomerate due to almost instantaneous adsorption of moisture on account of the hygroscopicity of sodium chloride. Furthermore, the salty taste which, although may be initially intense and satisfying, often quickly disappears.

In the art, it is also known to provide methods of production of small salt particles (i.e. less than approximately 100 μm) that are stabilized by prevention of particle agglomeration by forming the small salt crystals or particles on and/or within “carrier” granules or spheres of a larger size (i.e. greater than approximately 100 μm). Such methods make use of aqueous solutions (or solutions using other solvents) and a variety of drying methods to manufacture the particles.

Again, however, such “wet” methods of manufacture have significant limitations. In the case of spherical, hollow particles, it is difficult to prepare particles over 100 μm in size without also encountering a not-insignificant degree of particle breakage (leading to fragments). By way of example, in certain manufacturing methods working with particles having a low bulk density, especially below about 0.6 g/mL, results in significant dusting problems during manufacturing and poor flow properties. In general, low bulk density products (<0.6 g/mL) cannot be used as table top salt replacer product without addition of other materials, which is often poorly perceived by the consumer.

Furthermore, use of aqueous salt solutions in manufacture often leads to significant corrosion issues due to use of high chloride-content solutions, a problem exacerbated with expensive and often delicate equipment used for drying (e.g. spray-dryers and the like). Moreover, removal of large amounts of water from aqueous feeds is an inherently energy-intensive and expensive process, even if the long-term costs of corrosion are ignored.

And, again, the problem of an often rapidly disappearing initial salty taste remains.

It would therefore be desirable to at least mitigate the problem of a rapidly disappearing initial salty taste and indeed at the same time to address all of the other problems identified above with the production of reduced size salt particles, having an average size of less than 100 μm. It would be desirable to provide a method of production of an edible composition having an improved taste temporal profile, which is widely applicable to other food and beverage ingredients with a view to an overall reduction in the amount consumed per unit measure, and which may be applied to senses other than simply taste, and to a novel edible composition per se.

According to a first aspect, the present invention provides a method of preparing a free-flowing, edible composition comprising a first edible material, having a first function-release profile, and a second edible material, having a second function-release profile, said method comprising the steps of:
(a) combining the first edible material, provided in dry particulate form, with the second edible material, provided in dry particulate form; and
(b) heating said combination to a forming temperature (T_{f}), which is at least equal to the glass transition temperature (T_{g}) of the first edible material, with concurrent mixing thereof, so as to coat particles of the first edible material with a plurality of particles of the second edible material, thereby forming composite particles of said composition.

The term “function-release profile” as used herein in relation to an edible material refers to the temporal profile of a particular inherent character/property/function of the material as modified by the immediate environment surrounding the edible material, which character/property/function is triggered or “released” in response to one or more environmental conditions. In other words, it refers to the manner in which the character/property/function of the material (as modified by the immediate environment surrounding the edible material) develops over time.

For example, an edible material may inherently possess one or more functions such as a particular taste, a particular colour-imparting character, a particular preserving or tenderizing character, etc., which may be unmodified by its immediate surrounding environment (e.g. if present in air), and which is triggered upon human consumption of the material and its immediate contact with taste buds on the tongue, by dissolution on contact with an appropriate liquid, such as saliva, water or vinegar, etc.

Alternatively, the function(s) of the edible material may be modified by the immediate surrounding environment (e.g. because it is bound into a carrier material), such that the function(s) is only triggered once the edible material is released from its immediate surrounding environment, e.g. the carrier material, such as by dissolution thereof.

Although, as mentioned above, one of the functions that an edible material may possess may include a particular taste, a particular colour-imparting character, a particular preserving or tenderizing character, etc., the most preferred function is a particular taste. Thus although the edible material may be a seasoning, a colouring or agent for the preservation, tenderization, curing, plumping, canning and/or pickling of foodstuffs, the most preferred is a seasoning.

As described above, the character/property/function of an edible material is triggered or “released” in response to one or more environmental conditions. Preferably, the second function-release profile of the second edible material (that forming the coating on the particles) may be an immediate release profile, with “immediate” in this sense meaning that the character/property/function of the second edible material is released in less than ten (10) seconds, preferably less than five (5) seconds, more preferably in less than two (2) seconds and most preferably in less than one (1) second such that there is no discernible delay between exposing the edible material to the appropriate environmental condition and the function of the second edible material being perceived. Thus, the second edible material forming the coating may provide an immediate function, e.g. an instant release of a taste or a colour, etc.

Advantageously, the first function-release profile of the first edible material (that forming the core of the particles) may be a “controlled” or “prolonged” release profile, in the sense that the character/property/function of the first edible material is released over a period of about five to about thirty (5-30) seconds, preferably over a period of about five to about twenty (5-20) seconds, and, as appropriate, most preferably prior to swallowing of the edible composition (it having been consumed) and preferably during the period of mastication of a foodstuff provided with the edible composition. Thus onset of the function of the first edible material may be delayed by a period of five (5) seconds, possibly even ten (10) seconds after exposure of the edible material to the appropriate environmental condition. As noted above, the controlled or prolonged release of the first edible material may be due to the inherent character/property/function of the material per se, or it may be caused by its modification by the immediate surrounding environment (e.g. because it is bound into a carrier material), such that the function(s) is only triggered once the edible material is released from its immediate surrounding environment, e.g. the carrier material, such as by dissolution thereof.

For both the first function-release profile and the second function-release profile, exposure to the appropriate environmental condition, from which the period of release is measured, may be delivery of the edible composition to an aqueous environment, such as the mount of a human as the edible composition is consumed.

The method according to the first aspect of the invention is a “dry” method, i.e. no solvent is explicitly added to the combination of first and second edible materials during step (a) and/or step (b). Each of the first and second edible materials is thus “dry” in this sense, but each may inherently include a low percentage by weight of water, typically less than 10% by weight, but which are still to be considered as “dry” for the purposes of the present invention due to lack of explicitly added solvent. The benefits of operating a dry preparation method are numerous, including a reduction in the operational and capital costs as compared to known “wet” methods, and an increase in the operational lifetime of the equipment needed to perform the method, particularly given that the prior art problem of corrosion is mitigated with a dry process.

The method produces a free-flowing composition, which does not require the addition of further ingredients to achieve the desired flowability of the composition, in the form of composite particles. Caking and agglomeration of the composite particles is minimised if not completely eliminated. Furthermore, the method produces a free-flowing composition for which prior art problems of dusting are also mitigated.

Beneficially, a third edible material, having a third function-release profile, may be admixed with the first edible material prior to step (a) of the method to form a mixed edible core material in dry particulate form, which is subsequently combined with the second edible material in step (a), prior to said combination being heated in step (b). In other words, the composite particles formed would have a core that is a mixture of the first and third edible materials, said core being coated with particles of the second edible material.

The “mixture” of first and third edible materials in the core of a composite particle may be selected from any of the following:
i. particles of the first and third edible materials being co-mingled and substantially evenly co-distributed in the core
ii. particles of the third edible material being dispersed in an amorphous matrix of the first edible material, and vice versa
iii. particles of the third edible material forming an amorphous coating layer or outer shell around the first edible material (provided in particulate or amorphous matrix form), and vice versa.

In some embodiments, in which (i) particles of the first and third edible materials may be being co-mingled and substantially evenly co-distributed in the core or (ii) particles of the third edible material may be dispersed in an amorphous matrix of the first edible material, or vice versa, the particulates of such mixed edible core material may be provided with an amorphous coating layer or outer shell of a material selected from the first edible material, the third edible material or a fourth edible material prior to step (a). The fourth edible material may have a glass transition temperature (T_{g}) which is less than or equal to the T_{g} of the first edible material.

In some embodiments, the third edible material may be the same material as the second edible material, but the third function-release profile may be different to the second function-release profile. In other words, the second and third edible materials may be the same material, but may be of different particle sizes so as to possess inherently different function-release profiles. In this way, the coating of the composite particles may provide, e.g. an immediate taste, with a prolonged release of the same taste being provided by the third edible material in the core.

In some embodiments, a (yet) further edible material, having a further function-release profile, may be admixed with the second edible material prior to step (a) to form a mixed edible coating material in dry particulate form, which is subsequently combined with the first edible material in step (a), prior to said combination being heated in step (b). In other words, the composite particles formed would have a core of first edible material coated with a coating that is a mixture of the second and further edible materials.

The “mixture” of second and further edible materials in the coating of a composite particle may be selected from any of the following:
i. particles of the second and further edible materials being co-mingled and substantially evenly co-distributed in the coating
ii. particles of the second edible material being dispersed in an amorphous matrix of the further edible material, and vice versa
iii. particles of the second edible material forming an amorphous coating layer or outer shell around the further edible material (provided in particulate or amorphous matrix form), and vice versa.

In some embodiments, the further edible material may be a different material to the second edible material, but the further function-release profile may be the same as the second function-release profile. In other words, the second and further edible materials may be different materials, but may be of substantially the same particle sizes so as to possess substantially similar function-release profiles. In this way, the mixed coating of the composite particles may provide, e.g. an immediate mixtures of two tastes (such as salt and pepper), with a prolonged release of the first edible material provided by the core.

In some embodiments, the further edible material may be the same material as the third edible material, but the further function-release profile may be different to the third function-release profile. In other words, the composite particles formed would have a mixed core of the first and third edible materials, coated with a mixed coating of the second and further edible materials, such that the mixed coating provides an immediate release of two functions, whilst the mixed core provides a prolonged release of two functions.

Advantageously, in relation to any aspect of the foregoing, the second edible material may itself comprise a plurality of composite particles, each comprising a core of at least one edible material coated with a plurality of particles of at least one other edible material. Thus, the coating on the composite particles may be made of further composite particles.

Preferably, each of the at least one edible material and the at least one other edible material may be independently selected from any of the aforementioned first, second, third and further edible materials.

For the avoidance of any doubt, through the remainder of this specification, and unless otherwise explicitly stated, reference to a “first edible material” and to a “second edible material” includes any and all of the above “pre-combinations” and variants which are described in relation to third, fourth and further edible materials in combination with the first and/or second edible materials.

The method in accordance with the first aspect of the invention therefore provides a readily accessible way in which to quickly and simply control the sensory profile of an edible composition. Clearly, it is possible to select and control the types of edible material(s) to be incorporated into the composition, the particle sizes of said composition, the manner in which the different material(s) are combined and included in a composition, including, e.g. encapsulation/matrix-forms of the core and partitioning between the core and the discontinuous shell, to manipulate the morphology/structure of the composition.

In addition to respectively having a first function-release profile and a second function-release profile, each of the first and second edible materials defined in the method has a glass transition temperature (T_{g1}) and (T_{g2}) respectively, which are material-specific temperatures at which each material changes from a hard/brittle/glassy state to a viscous/rubbery state. The combination of first and second edible materials is heated to a forming temperature (T_{f}) which is the same as, or greater than, the glass transition temperature (T_{g1}) of the first edible material.

With concurrent mixing of the combined first and second edible materials, a discontinuous coating, having a rough surface morphology, composed of discrete particles of the second edible material is formed over substantially the entire available surfaces of particles of the first edible material. Such a rough surface is beneficial because it increases the available surface area of second edible material (as compared to a continuous surface for the same-sized particle of first edible material), which aids dissolution thereof. Because the coating is discontinuous, it may be formed over less than 100% of the available surface area of a particle of first edible material, however, it is preferred that coverage is maximised to 100% in so far as is possible given any limitation on the duration of the overall method.

In step (b), the combination of first and second edible materials may be maintained at the forming temperature (T_{f}) for a period of in the range of from about 10 to 40 minutes, preferably in the range of from about 20 to 30 minutes, but preferably no longer than about 1 hour, so as to ensure that energy costs savings are not lost and to avoid any possible adverse side reactions that may occur. Of course, a person skilled in the art will appreciate that the processing time will ultimately depend on the equipment used to perform the method, as well as the processing conditions employed.

Further preferably, the combination may be continuously mixed whilst being maintained at the forming temperature (T_{f}).

In one embodiment of the invention, in step (a), the first edible material may be combined with the second edible material to form a blended mixture of desired distribution prior to performance of step (b). Such a blended mixture may lead to a substantially uniform mutual distribution of the two materials. In this embodiment, the blended mixture is formed prior to subjecting it to the heating of step (b).

Thereafter, in step (b), the blended mixture is heated to the forming temperature (T_{f}), at which it may remain for a period in the region of 5 to 20 minutes. Separation of steps (a) and (b) into two distinct steps means that the method may be operated as a batch method, in which a quantity of edible composition is prepared in appropriate mixing and heating equipment and subsequently removed prior to a second quantity being identically prepared, or as a continuous method in which a constant stream of edible composition is prepared by feeding first and second edible materials through appropriate mixing and heating equipment on a continuous basis. For both batch operation and continuous operation, the heating vessel used for step (b) may be kept at or around the forming temperature because the first and second edible materials are pre-blended (in step (a)) prior to their introduction thereto.

In an alternative embodiment of the invention, steps (a) and (b) may be performed substantially, if not entirely, simultaneously, such that the first edible material may be combined with the second edible material to form a blended mixture of desired mutual distribution whilst said materials are heated to the forming temperature (T_{f}). By ensuring that the materials are brought to the desired blend whilst being heated, the same quality of edible composition as may be achieved via the alternative embodiment described above may be obtained, however, this one-step method may only be suitable for batch operation as the heating vessel would need to be cooled (to prevent overly rapid heating of the materials) between batches.

Combination of the first and second edible materials in step (a), and heating of the combination of first and second edible materials in step (b), of the method of the invention may be performed in any suitable device having both material agitation and heating capability, particularly heat-capable low-shear mixing devices, such as dry blenders, blending/propelling augers, horizontal reactors, tumblers, and the like.

Beneficially, the composite particles of the edible composition may have a mean particle size in the range of from about 50 μm to about 5000 μm. For certain applications, e.g. use of the edible composition as tabletop salt, a particle size towards the lower end of the range may be suitable, e.g. from about 50 μm to about 800 μm, preferably from about 100 μm to about 500 μm, further preferably from about 150 μm to about 350 μm. For certain other applications, i.e. certain other uses of the edible composition, such as salt seasoning for baked goods such as pretzels and biscuits, a particle size towards the upper end of the range may be suitable, e.g. from about 800 μm to about 5000 μm, preferably from about 1000 μm to about 3500 μm, further preferably from about 1500 μm to about 2500 μm. Such sizes are believed to provide the optimum ratio of taste to quantity of both first and second edible materials.

Further advantageously, the loose bulk density of the free-flowing edible composition may be greater than about 0.6 g/mL, and preferably in the range of from about 0.75 g/mL to about 1.0 g/mL. As briefly described above, a bulk density of this order is beneficial in that it assists with the non-dusting characteristics of the composition.

The mean particle size of the plurality of particles of second edible material may be in the range of from about 10 μm to about 250 μm. Typically, the mean particle size of the plurality of particles of second edible material may be less, optionally up to 50% less, than the mean particle size of the first edible material, although the size will ultimately be dependent on a number of performance factors including: the ratio of first edible material to second edible material, the desired mean particle size of the composite particles, the desired dissolution rate of the composite particles, etc.

As the first edible material is the material into which the plurality of particles of second edible material is embedded, the glass transition temperature (T_{g1}) of the first edible material may be lower than the glass transition temperature (T_{g2}) of the second edible material. In this way, only the first edible material may soften to enable embedding of the particles of the second edible material therein. Accordingly, the forming temperature may preferably be lower than the glass transition temperature (T_{g2}) of the second edible material.

The glass transition temperature (T_{g1}) of the first edible material may preferably be in the range of from about 20° C. to about 120° C., preferably from about 40° C. to about 80° C. and most preferably from about 50° C. to about 75° C. The forming temperature (T_{f}) is at least equal to T_{g1}, and may be at least around 10° C., preferably around 15° C. and up to around 35° C. higher than T_{g1}. T_{f} may be in the range of about 10-35° C. higher than T_{g1}, and preferably in the range of about 15-25° C. higher. Ultimately, the aim is to provide the particles of first edible material in a form such that the plurality of particles of the second edible material is able to “stick” (embed) into their outer surface to form the desired composite particles. A person skilled in the art, faced with the aim of providing a particular combination of first and second edible materials, would be able to judge the forming temperature (T_{f}) based on the glass transition temperatures of the materials in question. Furthermore, the higher the forming temperature, the short the processing time generally needed, and thus the lower the cost of performance of the method.

Each of the first, third, fourth and further edible materials may be independently chosen from a natural or synthetic edible carrier material, and may comprise any one or more of the following: monosaccharides, e.g. glucose, fructose, galactose, xylose; disaccharides, e.g. sucrose (e.g. refined sugar), lactose, maltose; oligosaccharides, e.g. maltodextrin; polysaccharides, e.g. starch, cellulose, soluble corn fibre, oats; salt; and derivatives thereof. Thus the first, third, fourth and further edible materials may be each be mixtures of any two or more of these carrier materials.

A more complete description of carrier materials from which the first, third, fourth and further edible materials may be independently selected follows in the next four paragraphs,

The carrier material may be an organic material, preferably a polymeric material. A wide variety of such polymeric materials may be used to produce composite particles in accordance with the invention, with preferred polymers having substantial solubility in an aqueous environment. The polymer may be natural or synthetic although there is a constraint in that it should be a polymer which is acceptable for alimentary purposes.

Examples of natural polymers include carbohydrates, e.g. oligosaccharides or polysaccharides, and proteins. Mixtures of such polymer types may also be used. If the polymer is a carbohydrate then it may, for example, be one or more of maltodextrin (e.g. Fibresol), gum arabic (e.g. acacia gum), starch (e.g. soluble corn starch, potato starch or soya bean starch), Merigel™ (starch), Mira-Mist™ SE (modified starch), Promitor™ Soluble Corn Fiber L70, locust bean gum (e.g. Genu™ locust bean gum), Maltosweet™ 120 (maltodextrin), gellan gum (e.g. Kelcogel™ F), pullulan, xanthan gum (e.g. Keltrol™ xanthan gum) and pectin (e.g. Genu™ pectin), guar gum, carageenan, hydroxypropyl cellulose, agar and the natural polymer Natto which is obtained by fermentation of soya beans using Bacillus subtilis to produce a “sticky product” on the surface of the beans, which may then be mixed with an equal volume of water and homogenised to produce Natto.

Although organic polymeric materials (that are solid at ambient temperature) are preferred, other organic materials may be used, e.g. fats such as plant or animal derived fats.

Examples of synthetic polymers that may be used include polyethylene glycol. The polyethylene glycol may, for example, have a molecular weight in the range 200-9,500.

Each of the second, third, fourth and further edible materials may be a natural or synthetic flavouring, colorant and/or preservative, i.e. each may provide any one or more of these functions. Preferably, the flavouring, colorant and/or preservative may comprise any one or more of the following: salt; garlic; taste enhancers, e.g. high potency sweeteners, yeast extract, potassium chloride; culinary herbs and spices, e.g. cinnamon, black, white or green pepper; monosaccharides, e.g. glucose, fructose, galactose, xylose; disaccharides, e.g. sucrose (e.g. refined sugar), lactose, maltose; oligosaccharides, e.g. maltodextrin; a further free-flowing edible composition; and derivatives thereof. Thus the second, third, fourth and further edible materials may each be a mixture of any two or more of these flavouring/colorant/preservative materials.

A more complete description of natural and synthetic flavourings from which the second, third, fourth and further edible materials may be independently selected follows in the next eleven paragraphs,

In embodiments of the invention, the flavouring may be selected from:
a sweetener;
a natural high potency sweetener;
a synthetic high-potency sweetener that is a glycoside; and
a synthetic high-potency sweetener that is derived from an amino acid.

A sweetener selected from the group consisting of: a nutritive sweetener, aspartame, acesulfame, cyclamate, saccharin and sucralose; and salts and/or solvates thereof.

In particular, the nutritive sweetener may be one or more selected from the group consisting of: a 3- to 12-carbon sugar alcohol (e.g. allose, deoxyribose, erythrulose, galactose, gulose, idose, lyxose, mannose, ribose, tagatose, talose, xylose, erythrose, fuculose, gentiobiose, gentiobiulose, isomaltose, isomaltulose, kojibiose, lactulose, altrose, laminaribiose, arabinose, leucrose, fucose, rhamnose, sorbose, maltulose, mannobiose, mannosucrose, melezitose, melibiose, melibiulose, nigerose, raffinose, rutinose, rutinulose, sophorose, stachyose, threose, trehalose, trehalulose, turanose, xylobiose), glucose-fructose syrup, invert sugar, arabitol, glycerol, hydrogenated starch hydrolysate, isomalt, lactitol, maltitol, mannitol, sorbitol and xylitol; allulose (also known as D-psicose), high fructose corn syrup, glucose, erythritol, fructose and sucrose; and salts and/or solvates thereof.

The term “sweetener” as used herein refers to a substance that provides a sweet taste. In other words, the sweetener is a nutritive sweetener or a non-nutritive sweetener. However, in particular embodiments, the sweetener does not contain a sugar or a sugar alcohol. In other words, in particular embodiments, the sweetener is a non-nutritive sweetener, which refers to a sweetener that offers little to no calories when ingested.

The term “nutritive sweetener” as used herein refers to a sweetener that contains carbohydrate and provides energy. Nutritive sweeteners may be further classified into monosaccharides or disaccharides, which impart 4 kcal/g, or sugar alcohols (polyols), which provide an average of 2 kcal/g, as discussed in “Position of the American Dietetic Association: Use of nutritive and nonnutritive sweeteners” J. Am. Diet Assoc. 2004; 104(2):255-275.

The term “natural high potency sweetener” as used herein refers to a high potency sweetener obtained from a natural source. For example, a natural high potency sweetener may be used in its raw form (e.g. as a plant) or may be extracted or purified from the natural source. Natural high potency sweeteners include abrusoside A, baiyunoside, brazzein, curculin, cyclocarioside I, glycyphyllin, glycyrrhizic acid, hernandulcin, a Luo Han Guo extract, mabinlin, monatin, monellin, mukurozioside, osladin, periandrins, phlomisosides, phloridzin, phyllodulcin, polypodoside A, pterocaryoside A, pterocaryoside B, rubusoside, a stevia extract (e.g. steviol glycosides, or particularly a rebaudioside, such as rebaudioside A to F, M, N and X), thaumatin and trilobatin, and salts and/or solvates thereof.

The term “synthetic high potency sweetener” as used herein refers to a high potency sweetener that has been produced using one or more synthetic steps. Synthetic high potency sweeteners that may be mentioned in certain embodiments of the invention include alitame, aspartame, a glucosylated steviol glycoside, N4N-[3-(3-hydroxy-4-methoxyphenyl)propyl]-L-[alpha]-aspartylFL-phenylalanine 1-methyl ester, N—[N43-(3-hydroxy-4-methoxyphenyl)-3-methylbutylFL-[alpha]-aspartyl]-L-phenylalanine 1-methyl ester, N4N-[3-(3-methoxy-4-hydroxyphenyl)propyl]-L-[alpha]-aspartylFL-phenylalanine 1-methyl ester, neohesperidin, dihydrochalcone, and neotame, and salts and/or solvates thereof.

The term “high-potency sweetener that is a glycoside” as used herein refers to a high potency sweetener that is a molecule in which a sugar is bound to an organic moiety that is not itself a sugar. High-potency sweeteners that are glycosides include abrusoside A, baiyunoside, cyclocarioside I, dulcoside A, dulcoside B, glycyphyllin, glycyrrhizic acid, a glucosylated steviol glycoside, mogrosides (e.g. mogroside IV, mogroside V), mukurozioside, neomogroside, osladin, periandrins, phlomisosides, phloridzin, polypodoside A, pterocaryoside A, pterocaryoside B, a rebaudioside (e.g. rebaudioside A, rebaudioside B, rebaudioside C, rebaudioside D, rebaudioside E, rebaudioside F, rebaudioside M, rebaudioside N, rebaudioside X), rubusoside, siamenoside, stevia, stevioside, trilobatin and neohesperidin dihydrochalcone.

The term “high-potency sweetener that is derived from an amino acid” as used herein refers to high potency sweetener that contains at least one amino acid as part of its molecular structure. High potency sweeteners that are derived from an amino include monatin (e.g. monatin, monatin SS, monatin RR, monatin RS, monatin SR), N—[N-[3-(3-hydroxy-4-methoxyphenyl)propyl]-L-[alpha]-aspartyl]-L-phenylalanine 1-methyl ester, N—[N-[3-(3-hydroxy-4-methoxyphenyl)-3-methylbutyl]-L-[alpha]-aspartyl]-L-phenylalanine 1-methyl ester and N—[N-[3-(3-methoxy-4-hydroxyphenyl)propyl]-L-[alpha]-aspartyl]-L-phenylalanine 1-methyl ester, and salts and/or solvates thereof.

The term “Monk Fruit extract” or “Luo Han Guo extract” as used herein refers to an extract or sample taken from a Monk Fruit from the Monk Fruit plant (i.e. a Luo Han Guo fruit from a Luo Han Guo plant), Siraitia grosvenorii, comprising at least one mogroside. The term “mogroside composition” as used herein refers to a composition comprising at least one mogroside.

The term “mogroside” as used herein refers to a family of compounds found in plants such as Monk Fruit, also known as Luo Han Guo. Mogrosides are glycosides of cucurbitane derivatives.

Preferably, the first and second edible materials may be provided in a ratio in the range of from about 1:0.8 to about 1:8, depending on the respective mean particle sizes of the two materials. Typically, the greater the difference in the mean particle size between the two materials, the lower the ratio.

In preferred embodiments of the invention, the method of the invention may enable the preparation of edible compositions which may comprise any of the following first edible material/second edible material combinations:
crystalline fructose (e.g. Krystar™)/cinnamon, to provide a source of nutritive sweetener along with flavouring, e.g. for use as a cake-baking ingredient which exhibits reduced clumping;
a mixture of soluble corn fibre and maltodextrin/salt and pepper, to provide dietary fibre along with flavouring, e.g. for use as a tabletop seasoning replacement product;
soluble corn fibre/salt, to provide a source of dietary fibre along with flavouring/taste enhancement, e.g. for use as a breakfast cereal-manufacturing ingredient;
soluble corn fibre/salt derivative, such as Soda-Lo™ salt microspheres, to provide a source of dietary fibre along with flavouring/taste enhancement, e.g. for use as a bread-making ingredient;
soluble corn fibre/{further edible composition of a mixture of soluble corn fibre and maltodextrin/salt};
sucrose/allulose (a by-product of the fermentation of molasses), to provide a source of sweetness and energy, e.g. for use as a tabletop refined sugar replacement product.

According to a second aspect of the invention, there is provided a free-flowing edible composition comprising a plurality of composite particles, each composite particle comprising a core of a first edible material, having a first function-release profile, provided with a discontinuous surface coating formed from a plurality of particles of a second edible material, having a second function release profile.

Beneficially, each composite particle may further comprise a third edible material, having a third function-release profile, which is mixed with the first edible material in the core, around which the discontinuous surface coating is provided. In other words, the composite particles may have a core that is a mixture of the first and third edible materials, said core being coated with particles of the second edible material.

The “mixture” of first and third edible materials in the core of a composite particle may be selected from any of the following:
i. particles of the first and third edible materials being co-mingled and substantially evenly co-distributed in the core
ii. particles of the third edible material being dispersed in an amorphous matrix of the first edible material, and vice versa
iii. particles of the third edible material forming an amorphous coating layer or outer shell around the first edible material (provided in particulate or amorphous matrix form), and vice versa.

In some embodiments, in which (i) particles of the first and third edible materials may be being co-mingled and substantially evenly co-distributed in the core or (ii) particles of the third edible material may be dispersed in an amorphous matrix of the first edible material, or vice versa, the particulates of such mixed edible core material may be provided with an amorphous coating layer or outer shell of a material selected from the first edible material, the third edible material or a fourth edible material, and wherein the discontinuous surface coating may be provided around and on the exterior of said outer shell.

In some embodiments, the third edible material may be the same material as the second edible material, but the third function-release profile may be different to the second function-release profile. In other words, the second and third edible materials may be the same material, but may be of different particle sizes so as to possess inherently different function-release profiles. In this way, the coating of the composite particles may provide, e.g. an immediate taste, with a prolonged release of the same taste being provided by the third edible material in the core.

In some embodiments, each composite particle may further comprise a (yet) further edible material, having a further function-release profile, which may be mixed with the second edible material in the discontinuous surface coating. In other words, the composite particles formed would have a core of first edible material coated with a coating that is a mixture of the second and further edible materials.

The “mixture” of second and further edible materials in the coating of a composite particle may be selected from any of the following:
i. particles of the second and further edible materials being co-mingled and substantially evenly co-distributed in the coating
ii. particles of the second edible material being dispersed in an amorphous matrix of the further edible material, and vice versa
iii. particles of the second edible material forming an amorphous coating layer or outer shell around the further edible material (provided in particulate or amorphous matrix form), and vice versa.

In some embodiments, the further edible material may be a different material to the second edible material, but the further function-release profile may be the same as the second function-release profile. In other words, the second and further edible materials may be different materials, but may be of substantially the same particle sizes so as to possess substantially similar function-release profiles. In this way, the mixed coating of the composite particles may provide, e.g. an immediate mixtures of two tastes (such as salt and pepper), with a prolonged release of the first edible material provided by the core.

In some embodiments, the further edible material may be the same material as the third edible material, but the further function-release profile may be different to the third function-release profile. In other words, the composite particles formed would have a mixed core of the first and third edible materials, coated with a mixed coating of the second and further edible materials, such that the mixed coating provides an immediate release of two functions, whilst the mixed core provides a prolonged release of two functions.

Advantageously, in relation to any aspect of the foregoing, the second edible material may comprise a plurality of composite particles, each comprising a core of at least one edible material coated with a plurality of particles of at least one other edible material.

Preferably, each of the at least one edible material and the at least one other edible material may be independently selected from any of the aforementioned first, second, third and further edible materials.

The edible composition in accordance with the second aspect of the invention therefore possesses a sensory profile which is quick and simple to control. Clearly, it is possible to select and control the types of edible material(s) to be incorporated into the composition, the particle sizes of said composition, the manner in which the different material(s) are combined and included in a composition, including, e.g. encapsulation/matrix-forms of the core and partitioning between the core and the discontinuous shell, to manipulate the morphology/structure of the composition.

Beneficially, the composite particles of the edible composition may have a mean particle size in the range of from about 50 μm to about 5000 μm. For certain applications, e.g. use of the edible composition as tabletop salt, a particle size towards the lower end of the range may be suitable, e.g. from about 50 μm to about 800 μm, preferably from about 100 μm to about 500 μm, further preferably from about 150 μm to about 350 μm. For certain other applications, i.e. certain other uses of the edible composition, such as salt seasoning for baked goods such as pretzels and biscuits, a particle size towards the upper end of the range may be suitable, e.g. from about 800 μm to about 5000 μm, preferably from about 1000 μm to about 3500 μm, further preferably from about 1500 μm to about 2500 μm. Such sizes are believed to provide the optimum ratio of taste to quantity of both first and second edible materials.

Further advantageously, the loose bulk density of the free-flowing edible composition may be greater than about 0.6 g/mL, and preferably in the range of from about 0.75 g/mL to about 1.0 g/mL. As briefly described above, a bulk density of this order is beneficial in that it assists with the non-dusting characteristics of the composition.

The mean particle size of the plurality of particles of second edible material may be in the range of from about 10 μm to about 250 μm, provided that the mean particle size of the particles of second edible material preferably may be less than the mean particle size of the composite particles. Typically, the mean particle size of the plurality of particles of second edible material may be less, optionally up to 50% less, than the mean particle size of the first edible material, although the size will ultimately be dependent on a number of performance factors including: the ratio of first edible material to second edible material, the desired mean particle size of the composite particles, the desired dissolution rate of the composite particles, etc.

As the first edible material is the material into which the plurality of particles of second edible material is embedded, the glass transition temperature (T_{g1}) of the first edible material may be lower than the glass transition temperature (T_{g2}) of the second edible material. In this way, only the first edible material may soften to enable embedding of the particles of the second edible material therein. Accordingly, the forming temperature may preferably be lower than the glass transition temperature (T_{g2}) of the second edible material.

The glass transition temperature (T_{g1}) of the first edible material may preferably be in the range of from about 20° C. to about 120° C., preferably from about 40° C. to about 80° C. and most preferably from about 50° C. to about 75° C.

The first edible material may be a natural or synthetic edible carrier material, and may comprise any one or more of the following: monosaccharides, e.g. glucose, fructose, galactose, xylose; disaccharides, e.g. sucrose (e.g. refined sugar), lactose, maltose; oligosaccharides, e.g. maltodextrin; polysaccharides, e.g. starch, cellulose, soluble corn fibre, oats; salt; and derivatives thereof. Thus the first edible material may be a mixture of any two or more of these carrier materials.

A more complete description of carrier materials from which the first, third, fourth and further edible materials may be independently selected is described earlier in this specification,

The second edible material may be a natural or synthetic flavouring, colorant and/or preservative, i.e. the second edible material may provide any one or more of these functions. Preferably, the flavouring, colorant and/or preservative may comprise any one or more of the following: salt; garlic; taste enhancers, e.g. high potency sweeteners, yeast extract, potassium chloride; culinary herbs and spices, e.g. cinnamon, black, white or green pepper; monosaccharides, e.g. glucose, fructose, galactose, xylose; disaccharides, e.g. sucrose (e.g. refined sugar), lactose, maltose; oligosaccharides, e.g. maltodextrin; a further free-flowing edible composition; and derivatives thereof. Thus the second edible material may be a mixture of any two or more of these flavouring/colorant/preservative materials.

A more complete description of natural and synthetic flavourings from which the second, third, fourth and further edible materials may be independently selected is described earlier in this specification,

Preferably, the first and second edible materials may be provided in a ratio in the range of from about 1:0.8 to about 1:8, depending on the respective mean particle sizes of the two materials. Typically, the greater the difference in the mean particle size between the two materials, the lower the ratio.

In preferred embodiments of the invention, the edible compositions may comprise any of the following first edible material/second edible material combinations:
crystalline fructose (e.g. Krystar™)/cinnamon, to provide a source of nutritive sweetener along with flavouring, e.g. for use as a cake-baking ingredient which exhibits reduced clumping;
mixture of soluble corn fibre and maltodextrin/salt and pepper, to provide dietary fibre along with flavouring, e.g. for use as a tabletop seasoning replacement product;
soluble corn fibre/salt, to provide a source of dietary fibre along with flavouring/taste enhancement, e.g. for use as a breakfast cereal-manufacturing ingredient;
soluble corn fibre/salt derivative, such as Soda-Lo™ salt microspheres, to provide a source of dietary fibre along with flavouring/taste enhancement, e.g. for use as a bread-making ingredient;
soluble corn fibre/{further edible composition of a mixture of soluble corn fibre and maltodextrin/salt};
sucrose/allulose (a by-product of the fermentation of molasses), to provide a source of sweetness and energy, e.g. for use as a tabletop refined sugar replacement product.

An edible composition according to the invention may be provided as a substitute for, or as a co-ingredient to, currently available food ingredients such as tabletop (shaker) salt, tabletop pepper, tabletop sugar, etc, for use in the home, in restaurants and other food delivery/preparation facilities.

According to a third aspect of the invention there is provided a foodstuff or a beverage, which is seasoned, coloured and/or preserved with a free-flowing edible composition as hereinbefore described. Such foodstuffs include: potato and corn chips, salted peanuts, pretzels, bagels, salted confectionary, cookies (biscuits), breads, cakes, etc.

According to a fourth aspect of the invention there is provided a method of seasoning, colouring and/or preserving a foodstuff or a beverage comprising applying to, or incorporating in, the foodstuff or the beverage a free-flowing edible composition as hereinbefore described.

According to a fifth aspect of the invention there is provided a method of producing a foodstuff or a beverage comprising preparing a precursor of the foodstuff or beverage, incorporating the free-flowing edible composition as hereinbefore described, and cooking the precursor to produce the foodstuff or the beverage. This aspect of the invention may provide methods of producing foodstuffs such as potato and corn chips (crisps), salted peanuts, pretzels, bagels, salted confectionary, cookies (biscuits), breads, cakes, etc.

According to a sixth aspect of the invention there is provided a method of topically seasoning a foodstuff comprising applying to the foodstuff a free-flowing edible composition as hereinbefore described. Such foodstuffs include: potato and corn chips, salted peanuts, pretzels, bagels, salted confectionary, cookies (biscuits), breads, cakes, etc.

According to a seventh aspect of the invention there is provided a method of tenderising, curing, plumping or seasoning meats with a free-flowing edible composition, wherein said composition is provided by a free-flowing edible composition as hereinbefore described.

According to an eighth aspect of the invention there is provided a method of canning or pickling a foodstuff using a free-flowing edible composition, wherein said composition is provided by a free-flowing edible composition as hereinbefore described. Such a method is particularly, but not exclusively, suited for canning or pickling vegetables, fish and fish products.

According to a ninth aspect of the invention there is provided a method of achieving controlled/prolonged release of a seasoning, colouring and/or preserving agent from a foodstuff comprising applying to the foodstuff a free-flowing edible composition as hereinbefore described, such that, when the foodstuff is ingested, the function of the second edible material is released more quickly than the function of the first edible material.

For a better understanding, the present invention will now be more particularly described, by way of non-limiting example only, with reference to the accompanying drawings in which:

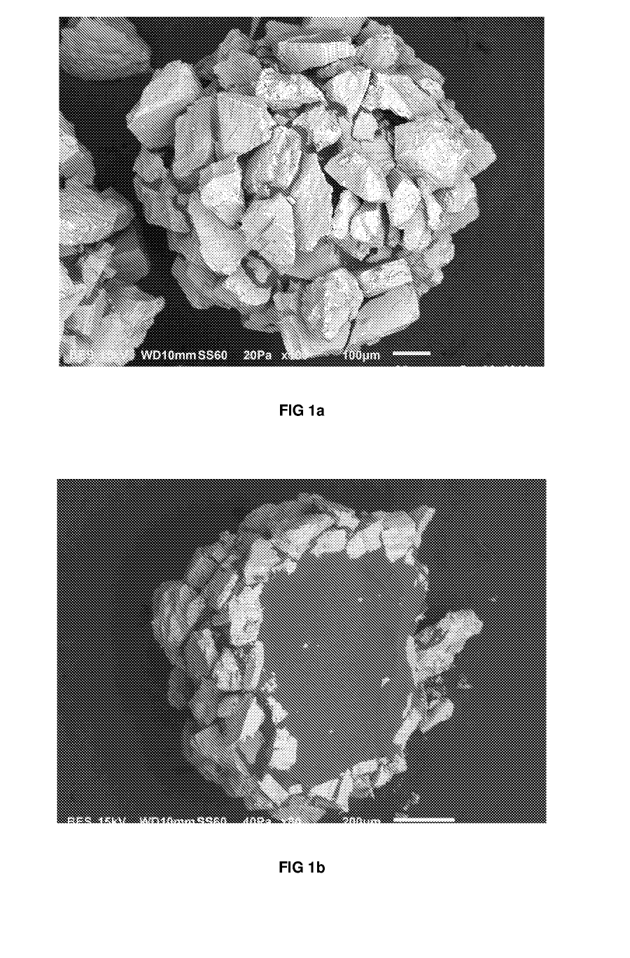

FIGS. 1a and 1b are scanning electron micrograph (SEM) images of one composite particle and a cross-section therethrough respectively according to a first embodiment of a free-flowing edible composition according to the second aspect of the invention;

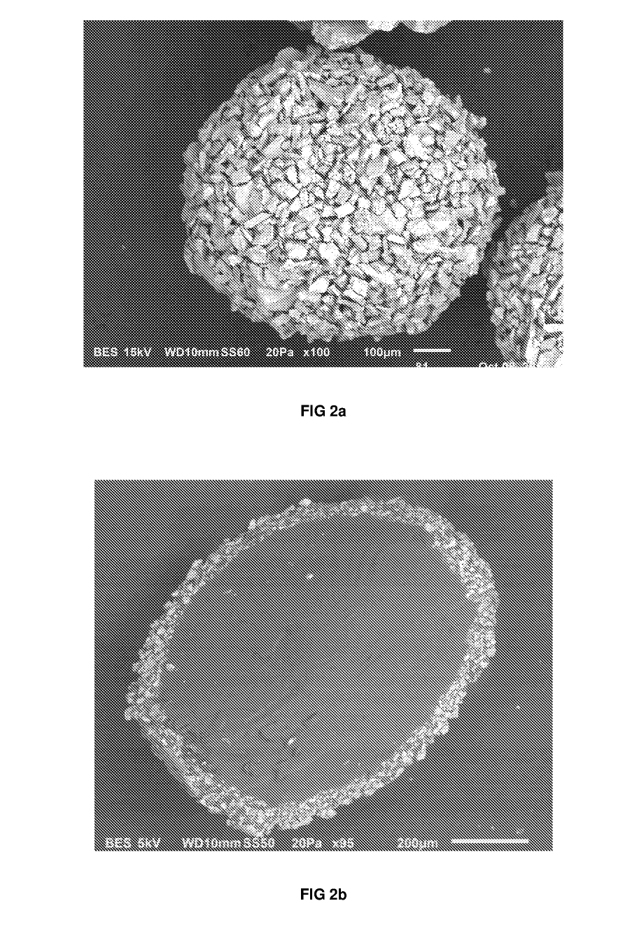

FIGS. 2a and 2b are SEM images of one composite particle and a cross-section therethrough respectively according to a second embodiment of a free-flowing edible composition according to the second aspect of the invention;

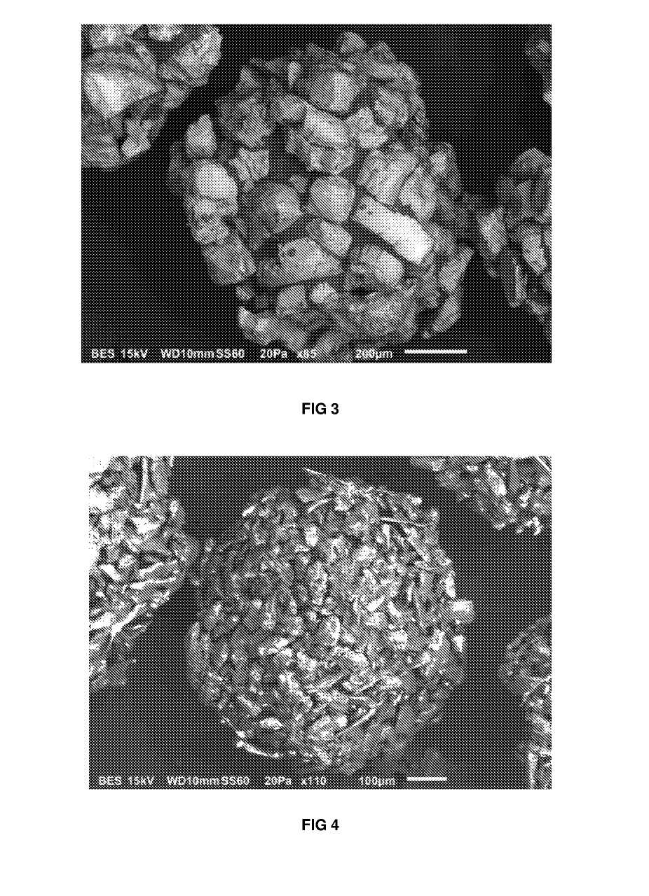

FIG. 3 is an SEM image of one composite particle according to a third embodiment of a free-flowing edible composition according to the second aspect of the invention;

FIG. 4 is an SEM image of one composite particle according to a fourth embodiment of a free-flowing edible composition according to the second aspect of the invention;

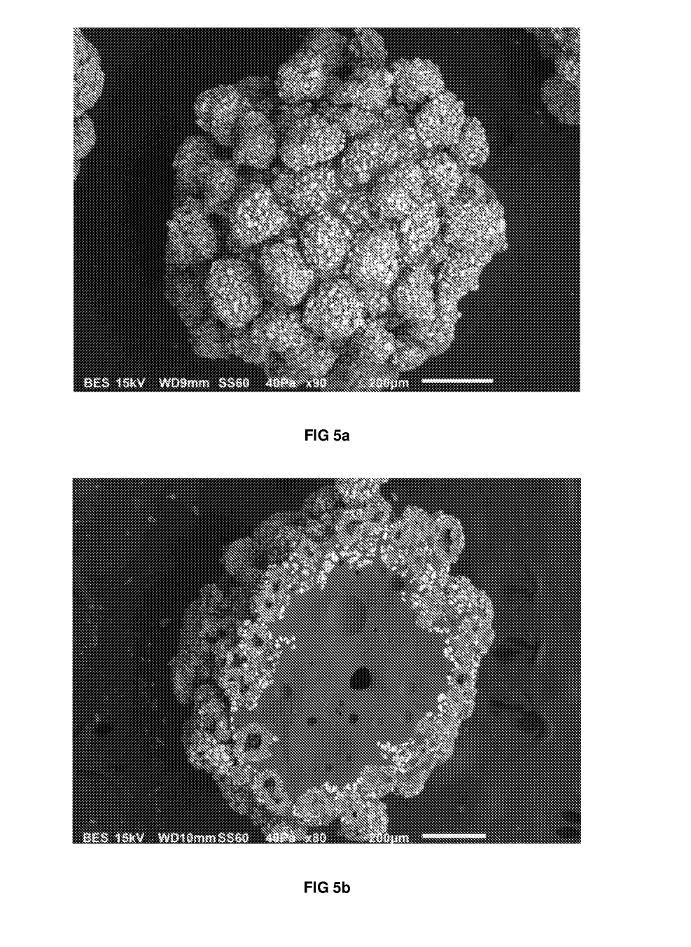

FIGS. 5a and 5b are SEM images of one composite particle and a cross-section therethrough respectively according to a fifth embodiment of a free-flowing edible composition according to the second aspect of the invention;

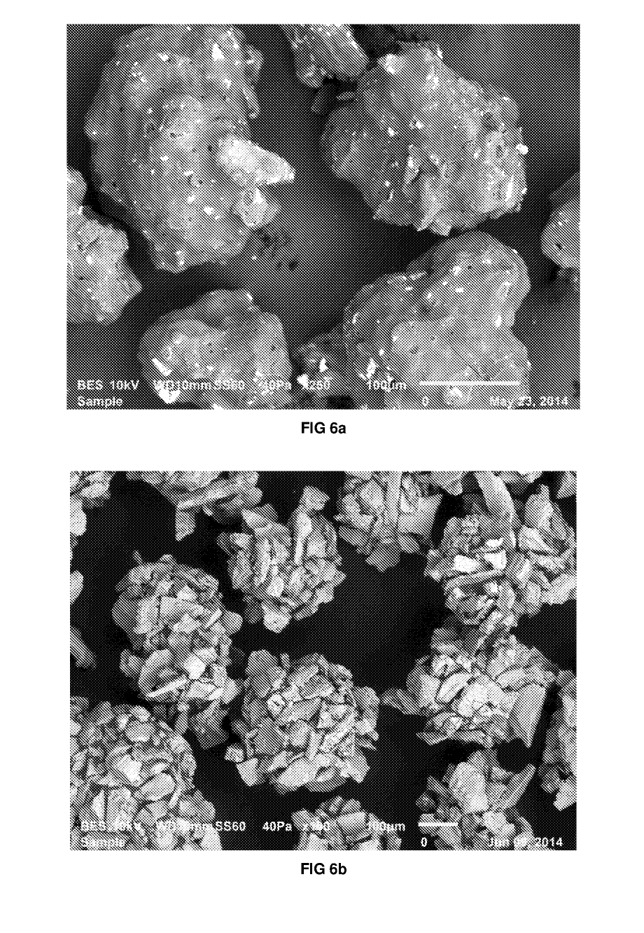

FIGS. 6a and 6b are SEM images of a core matrix of first and third edible materials and composite particles consisting of such cores and having a discontinuous shell according to a sixth embodiment of a free-flowing edible composition according to the second aspect of the invention;

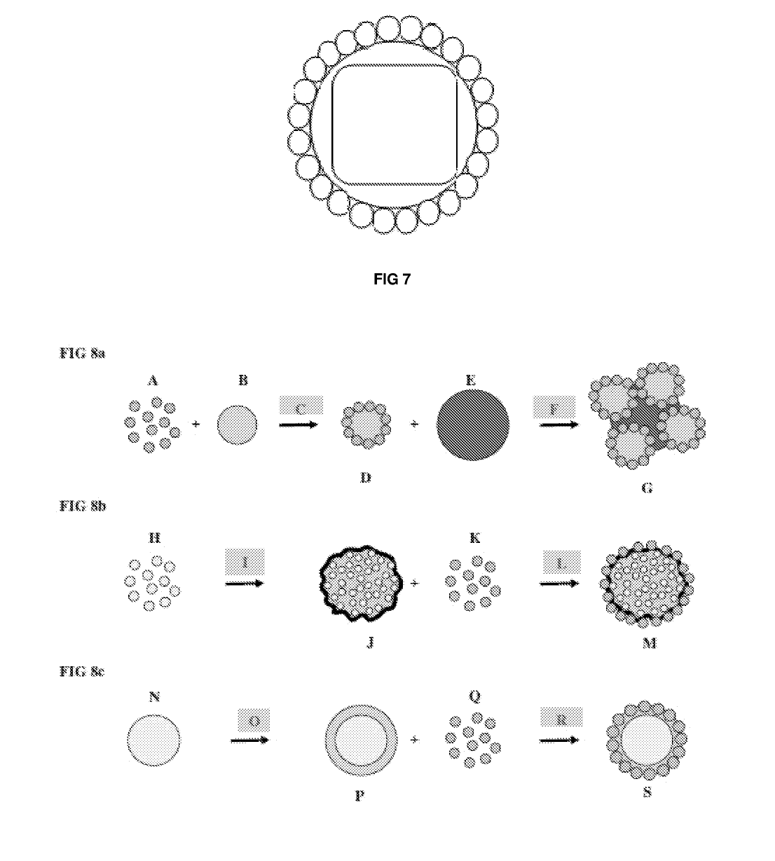

FIG. 7 is a stylised diagram showing the make-up of a composite particle according to a seventh embodiment of a free-flowing composition according to the second aspect of the invention; and

FIGS. 8a, 8b and 8c are simple schemes showing the processes and steps by which composite particles according to the invention may be made.

### EXAMPLE 1

FIGS. 1a and 1b show a composite particle of a free-flowing edible composition comprising a core carrier particle (first edible material having a first function-release profile) of a soluble corn fibre, e.g. Promitor™ Soluble Corn Fibre 70, provided with a discontinuous surface coating formed from a plurality of particles of salt (second edible material having a second function-release profile: the function being seasoning/flavouring and thus the sensation of taste). The composite particle itself has an average size in the region of 700-800 μm, with the plurality of salt particles having an average size in the region of 100-150 μm. Clearly, the bulk of the composite particle is composed of the core carrier particle, with only the outer “shell” being formed of the smaller salt particles.

### EXAMPLE 2

FIGS. 2a and 2b show a composite particle of a free-flowing edible composition comprising a core carrier particle (first edible material having a first function-release profile) of a soluble corn fibre, e.g. Promitor™ Soluble Corn Fibre 70, provided with a discontinuous surface coating formed from a plurality of particles of salt (second edible material having a second function-release profile: the function being seasoning/flavouring and thus the sensation of taste). The composite particle itself has an average size in the region of 750-850 μm, with the plurality of salt particles having an average size of less than 100 μm, in the region of 20-80 μm. Clearly, the bulk of the composite particle is composed of the core carrier particle, with only the outer “shell” being formed of the (much) smaller salt particles.

Comparing and contrasting the composite particles of Example 1 with Example 2, the much smaller salt particle sizes of Example 2 mean that such a composite particle is likely to dissolve (e.g. in a consumer's mouth) much more rapidly than the composite particle of Example 1, i.e. the taste-release profile of the salt particles used in each of Examples 1 and 2 are different, on account of the different salt particle sizes between the two.

Each of FIGS. 3 and 4 show further composite particles of a free flowing edible composition comprising two different core carrier particles (first and third edible materials having first and third function-release profiles respectively), although these cannot be seen directly, each provided with a discontinuous surface coating formed from a different plurality of particles of a second (and optionally fourth) edible material (s), having second (and fourth) function-release profile(s) (respectively).

### EXAMPLE 3

For the composite particle of FIG. 3, the first edible material is a mixture of soluble corn fibre (first edible material), e.g. Promitor™ Soluble Corn Fibre 70 and maltodextrin (second edible material), provided with a mixed surface coating of salt particles (third edible material) and pepper particles (fourth edible material). The composite particle itself has an average size in the region of 800-1000 μm, with the plurality of combined salt and pepper particles having an average size in the region of 100-200 μm. The taste-release profiles of the salt particles and the pepper particles respectively used in each of Examples 1 and 2 are different, on account of the different salt particle sizes between the two.

### EXAMPLE 4

For the composite particle of FIG. 4, the first edible material is fructose provided with a surface coating of cinnamon particles. The composite particle itself has an average size in the region of 650-750 μm, with the plurality of cinnamon particles having an average size of less than 100 μm.

### EXAMPLE 5

FIGS. 5a and 5b show a composite particle of a free-flowing edible composition comprising a core carrier particle (first edible material) of soluble corn fibre, e.g. Promitor™ Soluble Corn Fibre 70, provided with a discontinuous surface coating formed from a plurality of particles of a further free-flowing edible composition, which itself forms the second edible material. This further free-flowing edible composition comprises composite particles of salt on a mixture of soluble corn fibre and maltodextrin. Overall, the composite particle (rather than the sub-component composite particles) has an average size in the region of 1000-1200 μm, with the plurality of further (smaller) composite particles having an average size in the region of 150-250 μm. Clearly, the bulk of the composite particle is composed of the core carrier particle, with only the outer “shell” being formed of the further (smaller) composite particles. By combining the materials in this manner, it is possible to create an edible composition of three different ingredients (although only two are described above), each with its own function and dissolution properties.

In order to make any and all of the composite particles of edible compositions of Examples 1-5 shown in FIGS. 1 through 5, the following typical method of production may be performed in a heated dry blender:
(1) combine a first edible material, provided in dry particulate form, and a second edible material, provided in dry particulate form, by adding each separately or simultaneously into the blender;
(2) transfer the blender into a non-heated roller oven;
(3) turn on the roller to mix and blend the first and second edible materials for a period sufficient to ensure a blended mixture of desired distribution is formed;
(4) heat the oven to at least the forming temperature (T_{f}) of the first edible material and maintain for a period sufficient to ensure that particles of the first edible material are coated with a plurality of particles of the second edible material forming the desired composite particles;
(5) turn off the roller and remove the blender from the oven;
(6) optionally cool the blender and the resultant composite particles; and
(7) discharge the resultant free-flowing edible composition from the blender; and
(8) in respect of the composite particles of Example 5 only, repeat steps (1)-(7), but use the product obtained from steps (1)-(7) as the second edible material.

Such a method is a batch method and would require cooling of the blender (at least after the resultant composition has been discharged) prior to re-filling with a further quantity of first and second edible materials.

Alternatively, the method steps can be followed, suitably adapted, for performance as a continuous method in a continuous heated mixer.

### EXAMPLE 6

FIGS. 6a and 6b show a composite particle of a free-flowing edible composition comprising a core, which consists of a mixed core (of first and third edible materials in the form of maltodextrin and salt respectively) and a discontinuous shell of salt (second edible material). The core consists of discontinuous salt particles (third edible material) uniformly distributed in a matrix of maltodextrin (first edible material), whilst a further amount of salt particles (second edible material) forms the discontinuous shell.

This unique structure provides both an immediate release of salt as well as a controlled/prolonged release of salt. During consumption of, e.g. a foodstuff seasoned with the composition, the salt in the shell would quickly dissolve, providing a strong instant sensory experience, whilst the encapsulated salt inside the core would release gradually, providing an prolonged sensory experience, on account of the different taste-release profiles of the third edible material salt and the second edible material salt.

As is well known in the art, smaller salt particles dissolve quickly and provide a strong instant impact, however the salty taste then quickly disappears. Standard salt crystals are larger and take longer to dissolve which results in a lingering salty taste. The present inventors have discovered that by controlling the dissolution of the salt, the desired taste temporal profile can be achieved, such as in this example. The unique design of the particles also gives the expected appearance of salt.

Overall, the composite particle has an average size in the region of 250-500 μm, with the plurality of particles of second edible material having an average size in the region of 38-125 μm.

The following typical two-step method of production may be performed in an agglomerator, followed by a heated dry blender:

### Step 1

(1) feed a third edible material (salt), provided in dry particulate form into an agglomerator;
(2) spray the first edible material (carbohydrate), provided in a solution form, onto the third edible material at a first (faster) rate to make aggregated particles and then, coat the formed aggregates with the first edible material by spraying it at a second (slower) spray rate, forming a matrix core consisting of domains of third edible material in a matrix of first edible material (noting that the product formed is the same as that shown in state “J” in FIG. 8b, described in more detail below and as shown in FIG. 6a);

### Step 2

(3) combine the matrix cores and a second edible material, both provided in dry particulate form, by adding each separately or simultaneously into the blender;
(4) transfer the blender into a non-heated roller oven;
(5) turn on the roller to mix and blend the matrix cores and second edible material for a period sufficient to ensure a blended mixture of desired distribution is formed;
(6) heat the oven to at least the forming temperature (T_{f}) of the first edible material and maintain for a period sufficient to ensure that core matrix particles of the first and third edible materials are coated with a plurality of particles of the second edible material forming the desired composite particles, (noting that the product formed is the same as that shown in state “M” in FIG. 8b, described in more detail below and as shown in FIG. 6b);
(7) turn off the roller and remove the blender from the oven;
(8) optionally cool the blender and the resultant composite particles; and
(9) discharge the resultant free-flowing edible composition from the blender.

Such a method is a batch method and would require cooling of the blender (at least after the resultant composition has been discharged) prior to re-filling with a further quantity of edible materials.

Alternatively, the method steps can be followed, suitably adapted, for performance as a continuous method in a continuous heated mixer.

### EXAMPLE 7

FIG. 7 shows a theoretical composite particle of a free-flowing edible composition comprising a core, which consists of a mixed core (of first and third edible material in the form of carbohydrate and salt respectively) and a discontinuous shell of salt (second edible material). The core consists of salt (third edible material) that is coated in a thin layer of carbohydrate (first edible material), whilst a further amount of salt particles (second edible material) forms the discontinuous shell.

The salt used in the discontinuous shell can be comprised of a low density salt such as SODA-LO salt microspheres or Alberger flake salt to provide a lower overall bulk density and reduction in sodium for the same volume of salt.

This unique structure provides both an immediate release of salt as well as a controlled/prolonged release of salt. During consumption of, e.g. a foodstuff seasoned with the composition, the salt in the shell would quickly dissolve, providing a strong instant sensory experience, whilst the encapsulated salt inside the core would release gradually, providing an prolonged sensory experience, on account of the different taste-release profiles of the third edible material salt and the second edible material salt.

Overall, the composite particle has an average size in the region of 250-500 μm, with the plurality of particles of second edible material having an average size in the region of 10-125 μm.

The following typical two-step method of production may be performed using spray granulation, followed by a heated dry blender:

### Step 1

(1) feed a third edible material (salt), provided in dry particulate form into a spray granulator;
(2) spray the first edible material (carbohydrate), provided in a solution form, onto the third edible material at a first (slower) rate to form a coating on the third edible material, forming a matrix core consisting of a third edible material core coated in the first edible material (noting that the product formed is the same as that shown in state “D” in FIG. 8a, described in more detail below);

### Step 2

(3) combine the matrix cores and a second edible material, both provided in dry particulate form, by adding each separately or simultaneously into the blender;
(4) transfer the blender into a non-heated roller oven;
(5) turn on the roller to mix and blend the matrix cores and second edible material for a period sufficient to ensure a blended mixture of desired distribution is formed;
(6) heat the oven to at least the forming temperature (T_{f}) of the first edible material and maintain for a period sufficient to ensure that core matrix particles of the first and third edible materials are coated with a plurality of particles of the second edible material forming the desired composite particles (noting that the product formed is the same as that shown in state “G” in FIG. 8a, described in more detail below);
(7) turn off the roller and remove the blender from the oven;
(8) optionally cool the blender and the resultant composite particles; and
(9) discharge the resultant free-flowing edible composition from the blender.

Such a method is a batch method and would require cooling of the blender (at least after the resultant composition has been discharged) prior to re-filling with a further quantity of edible materials.

Alternatively, the method steps can be followed, suitably adapted, for performance as a continuous method in a continuous heated mixer.

Table 1 below details the combinations of first, second (and optionally third) ingredients used to form the composite particles shown in FIGS. 1 through 7, along with the ratios of said ingredients, the glass transition temperatures of the ingredients and the forming temperature used.

TABLE 1

| | First | Second | Third | | | | | | Loose Bulk |
|---|---|---|---|---|---|---|---|---|---|
| | Edible | Edible | Edible | Ratio | T_{g1} | T_{g2} | T_{g3} | T_{f} | Density |
| Example | Material | Material | Material | (1^{st}:2^{nd}:3^{rd}) | (° C.) | (° C.) | (° C.) | (° C.) | (g/mL) |
| 1 | Soluble Corn | Salt | — | 35:65:0 | 70-75 | — | — | 100 | 0.85 |
| | Fibre | | | | | | | | |
| 2 | Soluble Corn | Salt | — | 45:55:0 | 70-75 | — | — | 100 | 0.85 |
| | Fibre | | | | | | | | |
| 3 | Mixture of | Mixture of | — | 28:(56:8):0 | 70-75 | — | — | 100 | 0.83 |
| | Soluble Corn | Salt and | | | | | | | |
| | Fibre and | Pepper | | | | | | | |
| | Maltodextrin | | | | | | | | |
| 4 | Fructose | Cinnamon | — | 35:65:0 | 60-70 | — | — | 85 | 0.81 |
| 5 | Soluble Corn | Salt | Mixture of | 15:35:50 | 70-75 | — | 70-75 | 100 | 0.82 |
| | Fibre | | Soluble Corn | | | | | | |
| | | | Fibre and | | | | | | |
| | | | Maltodextrin | | | | | | |
| 6 | Soluble Corn | Salt | Salt | 40:25:35 | 70-75 | — | 70-75 | 100 | 0.81 |
| | Fibre or | | | | | | | | |
| | Maltodextrin | | | | | | | | |
| 7 | Soluble Corn | Salt | Low Density | 5:55:40 | 70-75 | — | 70-75 | 100 | 0.84 |
| | Fibre or | | Salt | | | | | | |
| | Maltodextrin | | | | | | | | |

The aforementioned combinations of ingredients could readily be adjusted to meet a range of desired attributes. For example, the ratios could be adjusted to give different taste profiles or to achieve differing levels of sodium reduction. To achieve a very low level of carbohydrate in the sample, a small particle of salt (100-300 μm) could be spray coated with a thin layer of carbohydrate. Furthermore, additional edible materials could be combined with any of the listed ingredients.

Turning now to FIGS. 8a, 8b and 8c, these figures show qualitatively how different combinations of material, as follows:

### FIG. 8a

Material A is particles of a second edible material which are combined with material B, which is a first edible material, using hot mixing (step C) to form a composite particle D in which particles of material A form a discontinuous coating around the core of material B.

Composite particle D is then combined with material E, which is either a further amount of the first edible material or is a fourth edible material, using a further hot mixing step (step F) to form composite particle G according to the invention.

### FIG. 8b

Material H is particles of a second edible material which are agglomerated/coated with a first edible material in an agglomeration/coating step (step I) to form a core matrix particle J, in which material H is encapsulated within the first edible material.

Core matrix particle J is then combined with material K, which is either a further amount of the second edible material or is a third edible material, using a hot mixing step (step L) to form composite particle M according to the invention.

### FIG. 8c

Material N is particles of a second edible material which are coated with a first edible material in a coating step (step O) to form a core particle P provided with an outer amorphous shell.

Coated core particle P is then combined with material Q, which is either a further amount of the second edible material or is a third edible material, using a hot mixing step (step R) to form composite particle S according to the invention.

Clearly, many variants and permutations are possible, not all of which have been explicitly exemplified, but all of which are within the scope of the present invention.

1. A method of preparing a free-flowing, edible composition comprising a first edible material, having a first function-release profile, and a second edible material, having a second function-release profile, said method comprising:
(a) combining the first edible material, provided in dry particulate form, with the second edible material, provided in dry particulate form; and
(b) heating said combination to a forming temperature (T_{f}), which is at least equal to the glass transition temperature (T_{g}) of the first edible material, with concurrent mixing thereof, so as to coat particles of the first edible material with a plurality of particles of the second edible material, thereby forming composite particles of said composition.

2. A method as claimed in claim 1 wherein a third edible material, having a third function-release profile, is admixed with the first edible material prior to step (a) to form a mixed edible core material in dry particulate form, which is subsequently combined with the second edible material in step (a), prior to said combination being heated in step (b).

3. A method as claimed in claim 2 wherein the particulates of mixed edible core material are provided with an outer shell of a material selected from the first edible material, the third edible material or a fourth edible material prior to step (a).

4. A method as claimed in claim 2 wherein the third edible material is the same material as the second edible material, but the third function-release profile is different to the second function-release profile.

5. A method as claimed in claim 1 wherein a further edible material, having a further function-release profile, is admixed with the second edible material prior to step (a) to form a blended edible coating material in dry particulate form, which is subsequently combined with the first edible material in step (a), prior to said combination being heated in step (b).

6. (canceled)

7. (canceled)

8. A method as claimed in claim 1 wherein the second edible material comprises a plurality of composite particles, each comprising a core of at least one edible material coated with a plurality of particles of at least one other edible material.

9. (canceled)

10. A method as claimed in claim 1 wherein, in step (b), the combination is maintained at the forming temperature (T_{f}) for a period in the range of from about 10 to 40 minutes.

11. A method as claimed in claim 1 wherein, in step (a), the first edible material is combined with the second edible material to form a blended mixture of desired distribution prior to performance of step (b).

12. A method as claimed in claim 1 wherein steps (a) and (b) are performed substantially simultaneously, such that the first edible material is combined with the second edible material to form a blended mixture of desired mutual distribution whilst said materials are heated to the forming temperature (T_{f}).

13. A method as claimed in claim 1 wherein combination of the first and second edible materials in step (a) is performed in a low-shear mixing device, optionally wherein the concurrent mixing of step (b) is performed in the same low-shear mixing device.

14. (canceled)

15. A method as claimed in claim 1 wherein the composite particles have a mean particle size in the range of from about 50 μm to about 5000 μm.

16. A method as claimed in claim 1 wherein the loose bulk density of the free-flowing edible composition is greater than about 0.6 g/mL.

17. A method as claimed in claim 1 wherein the mean particle size of the plurality of particles of second edible material is in the range of from about 10 μm to about 250 μm.

18. A method as claimed in claim 1 wherein the glass transition temperature (T_{g1}) of the first edible material is lower than the glass transition temperature (T_{g2}) of the second edible material.

19. A method as claimed in claim 1 wherein the glass transition temperature (T_{g1}) of the first edible material is in the range of from about 20° C. to about 120° C.

20. A method as claimed in claim 1 wherein the first edible material is a natural or synthetic edible carrier material selected from the group consisting of monosaccharides, glucose, fructose, galactose, xylose, disaccharides, sucrose, lactose, maltose, oligosaccharides, maltodextrin, polysaccharides, starch, cellulose, soluble corn fibre, oats and salt, and derivatives thereof.

21. A method as claimed in claim 1 wherein the second edible material is a natural or synthetic flavouring, colorant and/or preservative.

22. A method as claimed in claim 1 wherein the first and second edible materials are provided in a ratio in the range of from about 1:0.8 to about 1:8.

23. A method as claimed in claim 1 wherein the edible composition comprises any of the following first edible material/second edible material combinations:
crystalline fructose/cinnamon;
a mixture of soluble corn fibre and maltodextrin/salt and pepper;
soluble corn fibre/salt;
soluble corn fibre/salt derivative;
soluble corn fibre/{further edible composition of a mixture of soluble corn fibre and maltodextrin/salt};
sucrose/allulose.

24. A free-flowing edible composition comprising a first edible material, having a first function-release profile, and a second edible material, having a second function-release profile, obtained by the method of claim 1.

25. A free-flowing edible composition comprising a plurality of composite particles, each composite particle comprising a core of a first edible material, having a first function-release profile, provided with a discontinuous surface coating formed from a plurality of particles of a second edible material, having a second function-release profile.

26. A free-flowing edible composition as claimed in claim 25 wherein each composite particle further comprises a third edible material, having a third function-release profile, which is mixed with the first edible material in the core, around which the discontinuous surface coating is provided.

27. (canceled)

28. (canceled)

29. A free-flowing edible composition as claimed in claim 25 wherein each composite particle further comprises a further edible material, having a further function-release profile, which is mixed with the second edible material in the discontinuous surface coating.

30. (canceled)

31. (canceled)

32. A free-flowing edible composition as claimed in claim 25 wherein the second edible material comprises a plurality of composite particles, each comprising a core of at least one edible material coated with a plurality of particles of at least one other edible material.

33. (canceled)

34. A free-flowing edible composition as claimed in claim 25 wherein the composite particles have a mean particle size in the range of from about 50 μm to about 5000 μm.

35. A free-flowing edible composition as claimed in claim 25 having a loose bulk density greater than about 0.6 g/mL.

36. A free-flowing edible composition as claimed in claim 25 wherein the mean particle size of the plurality of particles of second edible material is in the range of from about 10 μm to about 250 μm.

37. A free-flowing edible composition as claimed in claim 25 wherein the glass transition temperature (T_{g1}) of the first edible material is lower than the glass transition temperature (T_{g2}) of the second edible material.

38. A free-flowing edible composition as claimed in claim 25 wherein the first edible material is a natural or synthetic edible carrier material selected from the group consisting of monosaccharides, glucose, fructose, galactose, xylose, disaccharides, sucrose, lactose, maltose, oligosaccharides, maltodextrin, polysaccharides, starch, cellulose, soluble corn fibre, oats and salt, and derivatives thereof.

39. A free-flowing edible composition as claimed in claim 25 wherein the second edible material is a natural or synthetic flavouring, colorant and/or preservative.

40. A free-flowing edible composition as claimed in claim 25 wherein the first and second edible materials are provided in a ratio in the range of from about 1:0.8 to about 1:8.

41. A free-flowing edible composition as claimed in claim 25 comprising any of the following first edible material/second edible material combinations:
crystalline fructose/cinnamon;
mixture of soluble corn fibre and maltodextrin/salt and pepper;
soluble corn fibre/salt;
soluble corn fibre/salt derivative;
soluble corn fibre/{further edible composition of a mixture of soluble corn fibre and maltodextrin/salt};
sucrose/allulose.

42. A foodstuff or a beverage seasoned, coloured and/or preserved with a free-flowing edible composition as claimed in claim 24.

43. A method of using a free-flowing edible composition as claimed in claim 25, the method being selected from the group consisting of
a method of seasoning, colouring and/or preserving a foodstuff or a beverage comprising applying to, or incorporating in, the foodstuff or the beverage the free-flowing edible composition;
a method of producing a foodstuff or a beverage comprising preparing a precursor of the foodstuff or beverage, incorporating the free-flowing edible composition, and cooking the precursor to produce the foodstuff or the beverage;
a method of topically seasoning a foodstuff comprising applying to the foodstuff the free-flowing edible composition;
a method of tenderising, curing, plumping or seasoning meats with the free-flowing edible composition;
a method of canning or pickling a foodstuff with the free-flowing edible composition; or
a method of achieving controlled/prolonged release of a seasoning, colouring and/or preserving agent from a foodstuff comprising applying to the foodstuff the free-flowing edible composition, such that, when the foodstuff is ingested, the function of the second edible material is released more quickly than the function of the first edible material.

44-48. (canceled)
